(19) United States
(12) Patent Application Publication
(10) Pub. No.: US 2016/0358077 A1
(43) Pub. Date: Dec. 8, 2016

(54) SYSTEM AND METHOD FOR QUANTIFYING AND PRESENTING INFORMATION REPRESENTATIVE OF TECHNOLOGICAL IMPROVEMENTS IN A TARGET TECHNOLOGICAL DOMAIN BASED ON PATENT METRICS

(71) Applicant: Massachusetts Institute of Technology, Cambridge, MA (US)

(72) Inventors: Christopher L. BENSON, Hill AFB, UT (US); Christopher L. MAGEE, Richmond, MA (US)

(21) Appl. No.: 14/729,382

(22) Filed: Jun. 3, 2015

(51) Int. Cl. G06N 5/02; G06F 17/30

(52) U.S. Cl. CPC G06N 5/02; G06F 17/30424

(57) ABSTRACT

Embodiments are disclosed herein for quantifying and presenting information representative of technological improvements in a technological domain based on patent metrics that may include receiving a request for a patent-based technological improvement rate in a target technological domain, selecting a set of patents representative of the technological domain from an online search of a patent database over a network, storing patent metadata in a memory for the set of patents received over the network from the online search of the patent database, calculating values for one or more patent metrics from the patent metadata for the technological domain, calculating the patent-based technological improvement rate for the technological domain by applying a predictive model to the one or more patent metric values for the technological domain, and communicating the patent-based technological improvement rate through an output communication interface for presentation through an output of an end user computing device.

### BACKGROUND

As technologies continue to improve at an exponential rate, there becomes an ever-greater need for understanding how technology has and will evolve. While it may be nearly impossible to fully predict how technology will change, even modest improvements in our ability to understand and potentially forecast technological change could create considerable impact in a number of areas where reducing the uncertainty of future technological capabilities is advantageous.

Much of the prior work to understand how technology changes over time has been focused around case studies. Quantitative data is sometimes part of the case study but usually the understanding or explanation is based upon narrative. The resulting qualitative theories include the linear model of innovation, the theory of radical inventions, the theory of disruptive innovations, life-cycle theory, S-curve theory, punctuated equilibrium and combinatorial knowledge-based innovation.

It is possible to quantify the improvement of a technological domain over time. One of the most famous examples of measuring technological progress is known as Moore's Law in the field of integrated circuit manufacture. According to Moore's Law, there is an exponential relationship between the ability to manufacture higher numbers of components on a single manufacturing die over time (i.e., doubling every two years). Understanding how technology changes over time and what capabilities are likely to exist in several years can influence how products are designed. For example, once software designers became aware of Moore's law and the rapid exponential improvement rate of computer processors, they began to push the limits of software programs at a similar pace.

While Moore popularized the time-based exponential relationship with integrated circuit manufacture, similar relationships have been found in other industries, such as information transmission, information storage and energy storage. The technological improvement rates within these fields have varied drastically from doubling every 2 years (˜35% improvement rate) to doubling every 17 years (˜4% improvement rate).

However, traditional techniques for obtaining such estimates of technological improvement rates are typically difficult, tedious, time-consuming and often result in estimates with low reliability. For example, estimates for technological improvement rates in a target technological domain are typically determined by constructing a functional performance metric (FPM) that is a measure of the generic function in a technological domain. An FPM may include factors that affect the purchasing decision for artifacts embodying the technology (e.g., Watts per U.S. dollar for solar photovoltaics). Next, data points that measure the FPM are collected from diverse sources over a long range of time and the technological improvement rate is determined by an exponential regression analysis of the FPM data points. However, the process of locating and compiling such FPM data points is typically very time consuming (e.g., weeks or months) and/or in some cases, the FPM data points may be difficult, if not impossible, to obtain and when obtained not always reliable for correctness.

### SUMMARY

The various embodiments provide methods, devices, and systems for quantifying and presenting information representative of technological improvements in a target technological domain based on patent metrics.

Embodiment methods for quantifying and presenting information representative of technological improvements in a target technological domain based on patent metrics may include a processor of a server computing device receiving a request for a patent-based technological improvement rate through an input communication interface, selecting a set of patents representative of the target technological domain from an online search of a patent database over a network, storing patent metadata in memory for the set of patents received over the network from the online search of the patent database, calculating values for one or more patent metrics from the patent metadata for the target technological domain, calculating the patent-based technological improvement rate for the target technological domain by applying a predictive model to the one or more patent metric values for the target technological domain, and communicating the patent-based technological improvement rate through an output communication interface for presentation through an output of an end user computing device. The request may include information for identifying a target technological domain. The request may also include information for identifying the target technological domain and an alternative technological domain.

In some embodiments, the method may further include the processor receiving a request through the input communication interface to forecast one or more value associated with a functional performance metric in the target technological domain, obtaining a reference value for the functional performance metric at a reference time in the target technological domain, obtaining the patent-based technological improvement rate for the target technological domain, calculating the requested forecast values for the technological domain according to an exponential function that increases over time at the patent-based technological improvement rate, and communicating the requested forecast values associated with the functional performance metric over an output communication interface for presentation at an output of an end user computing device.

In some embodiments, each of the patent metrics may correlate to technological improvement rates that are calculated based on historical functional performance metrics across a plurality of technological domains with a Pearson correlation coefficient greater than 0.50. The patent metrics may include one or more of an average number of forward citations within three years of publication per patent in the set of patents (FwdCit₃), an average publication date of backward citations per patent in the set of patents (PubYearBkwdCit), an average age of backward citations per patent in the set of patents (AgeBkwdCit), an average publication date of the set of patents (PubYear), and an average number of forward citations per patent in the set of patents (FwdCit).

In some embodiments, the predictive model may be derived from a regression analysis between values calculated for the one or more patent metrics across multiple technological domains and the technological improvement rates that are calculated based on historical functional performance metrics across the same technological domains.

In some embodiments, the patent metrics may include an average number of forward citations within three years of publication per patent in the set of patents (FwdCit₃) and an average publication date of the set of patents (PubYear), and the predictive model for the patent-based technological improvement rate (k) may be defined as k=−31.12+0.02*PubYear+0.14*FwdCit₃.

In some embodiments, the patent metrics may include an average number of forward citations per patent in the set of patents (FwdCit) and an average publication date of backward citations per patent in the set of patents (PubYearBkwdCit), and the predictive model for the patent-based technological improvement rate (k) may be defined as k=−41.37+0.014*FwdCit+0.020*PubYearBkwdCit.

In some embodiments, the patent metrics may include an average number of forward citations per patent in the set of patents (FwdCit), an average publication date of the set of patents (PubYear), and an average age of backward citations per patent in the set of patents (AgeBkwdCit), and the predictive model for the patent-based technological improvement rate (k) may be defined as k=−47.1+0.015*FwdCit+0.024*PubYear+(−0.018)*AgeBkwdCit.

Further embodiments include a computing device including a processor configured with processor-executable instructions to perform operations of the embodiment methods described above. Further embodiments include a non-transitory processor-readable storage medium having stored thereon processor-executable instructions configured to cause a processor to perform operations of the embodiment methods described above. Further embodiments include a computing device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a component block diagram illustrating an internetworked communication system that may be used in various embodiments.

FIG. 2 is a component block diagram illustrating a technological improvement rate (TIR) server suitable for use in various embodiments.

FIG. 3A is a process flow diagram illustrating an embodiment method for quantifying and presenting a patent-based technological improvement rate for a target technological domain.

FIG. 3B is a process flow diagram illustrating an embodiment method for quantifying functional performance metrics in a target technological domain using the patent-based technological improvement rate calculated according to the embodiment method of FIG. 3A.

FIG. 4A is a process flow diagram illustrating an embodiment method for selecting a set of patent representative of the technological domain using COM.

FIG. 4B is a process flow diagram illustrating an embodiment method for generating a predictive model that calculates patent-based technological improvement rates based on patent metrics across technological domains.

FIG. 5 is a diagram that identifies FPM-based technological improvement rates for a set of sample technological domains.

FIGS. 6A-6E are graphs illustrating exemplary patent metrics having suitable correlations to FPM-based technological improvement rates (TIR) across a set of sample technological domains.

FIGS. 7A-7C are tables illustrating exemplary predictive regression models based on various combinations of the patent metrics of FIGS. 6A-6E.

FIG. 8 illustrates an embodiment smartphone mobile device for use in various embodiments.

FIG. 9 is a component block diagram of another mobile computing device suitable for use in various embodiments.

FIG. 10 is a component block diagram of a server computing device suitable for use in various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The terms “mobile computing device” or “mobile device” or “computing device” are used interchangeably herein to refer to any one or all of desktop computers, cellular telephones, smart phones, personal or mobile multi-media players, personal data assistants (PDA's), laptop computers, tablet computers, smart books, retail terminals, palm-top computers, wireless electronic mail receivers, multimedia Internet enabled cellular telephones, wireless gaming controllers, and similar electronic devices which include a programmable processor and memory and circuitry for performing operations discussed herein, such as establishing network connections, receiving user input, and rendering data.

The various embodiments are described herein using the term “server.” The term “server” is used to refer to any computing device capable of functioning as a server, such as a application server, web server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application). A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

The various embodiments provide systems, methods, and devices for quantifying and presenting information representative of technological improvements in a target technological domain based on patent metrics that may be faster and easier than traditional techniques that are typically time consuming, tedious and labor intensive. In some embodiments, the various systems, methods, and devices may include receiving a request for a patent-based technological improvement rate in a target technological domain through an input communication interface, selecting a set of patents representative of the target technological domain from an online search of a patent database over a network, storing patent metadata in a memory for the set of patents received over the network from the online search of the patent database, calculating values for one or more patent metrics from the patent metadata for the target technological domain, calculating the patent-based technological improvement rate for the target technological domain by applying a predictive model to the one or more patent metric values for the target technological domain, and communicating the patent-based technological improvement rate through an output communication interface for presentation through an output of an end user computing device.

In some embodiments, the various systems, methods, and devices may also include receiving a request through the input communication interface to forecast one or more value associated with a functional performance metric in the target technological domain, obtaining a reference value for the functional performance metric at a reference time in the target technological domain, obtaining the patent-based technological improvement rate for the target technological domain, calculating the one or more requested forecast value for the technological domain according to an exponential function that increases over time at the patent-based technological improvement rate; and communicating the one or more requested forecast values associated with the functional performance metric over an output communication interface for presentation at an output of an end user computing device.

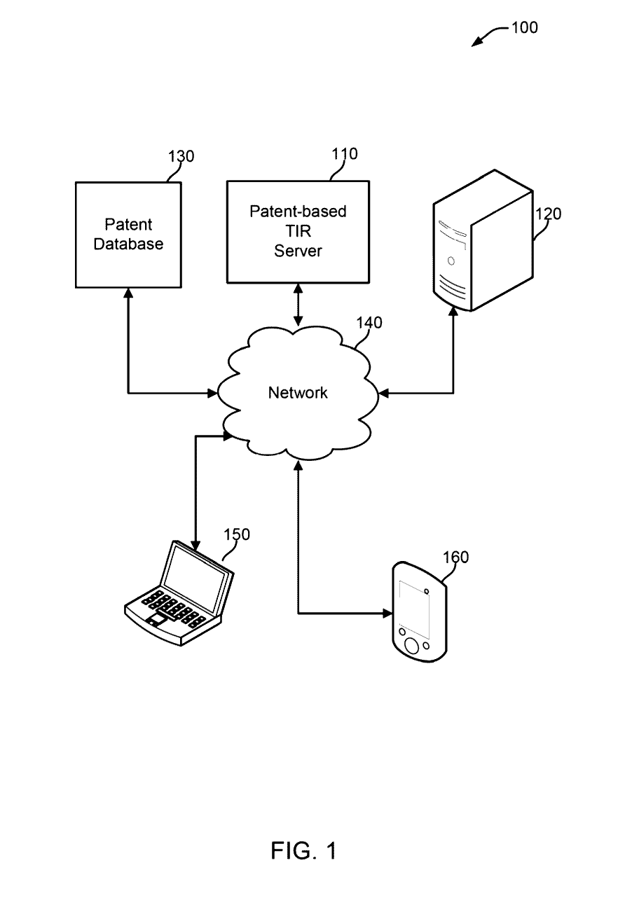

FIG. 1 is a component block diagram illustrating an internetworked communication system 100 that may be used in various embodiments. As shown, the communication system 100 may include a technological improvement rate (TIR) server 110, an application server 130, a searchable patent database 130, and one or more end user computing devices 150, 160. The TIR server 110 may quantify and present information representative of technological improvements in a target technological domain based on patent metrics. In some embodiments, the servers 110, 120, the patent database 130, and the end user computing devices 150, 160 may connected to and communicate over a network 140. The network may be the Internet or other wired or wireless network. Examples of the patent database 130 may include one or more patent databases of United States Patent and Trademark Office and/or other national or regional intellectual property office throughout the world. In some embodiments, the end user computing devices 150, 160 may connect to the network 140 and communicate directly with the TIR server 110 or indirectly through the application server 120. In some embodiments, the TIR server 110 and the application server 120 may be integrated as single server. In some embodiments, the functionality of TIR server 110 and the application server 120 may be incorporated as software modules executing on a processor within the end user computing devices 150, 160.

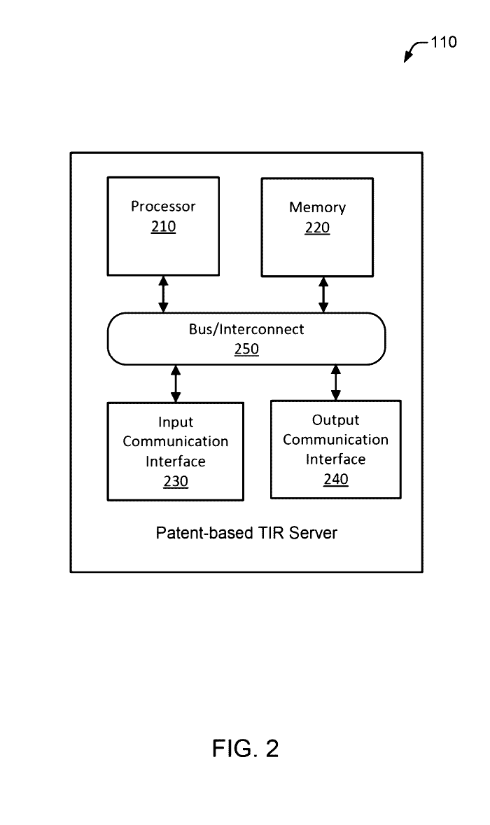

FIG. 2 is a component block diagram illustrating a TIR server 110 suitable for use in various embodiments. As shown, the TIR server 110 may include a processor 210, a memory 220, an input communication interface 230, and an output communication interface 240. Each of these components 210, 220, 230, and 240 may internally communicate with each other through a bus of other interconnect 250. In some embodiments, the input communication interface 230 may include one or more hardware components configured to receive input from a locally connected keyboard, mouse, touch screen panel, microphone, or from another end user computing device 140, 150 or server 120 over the network 140. In some embodiments, the output communication interface 240 may include one or more hardware components configured to output information to a locally connected display, speaker or to another end-user computing device 150, 160 or server 120 over the network 140.

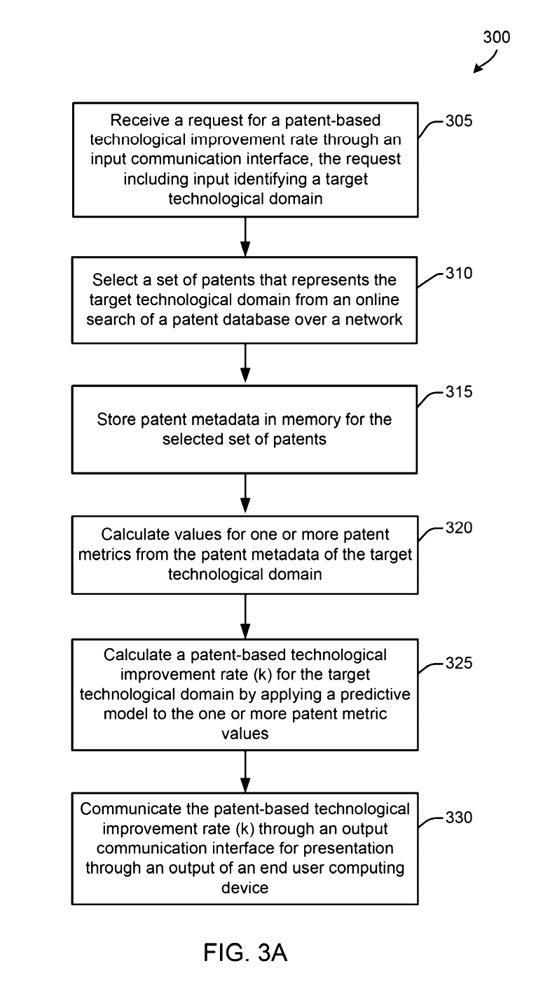

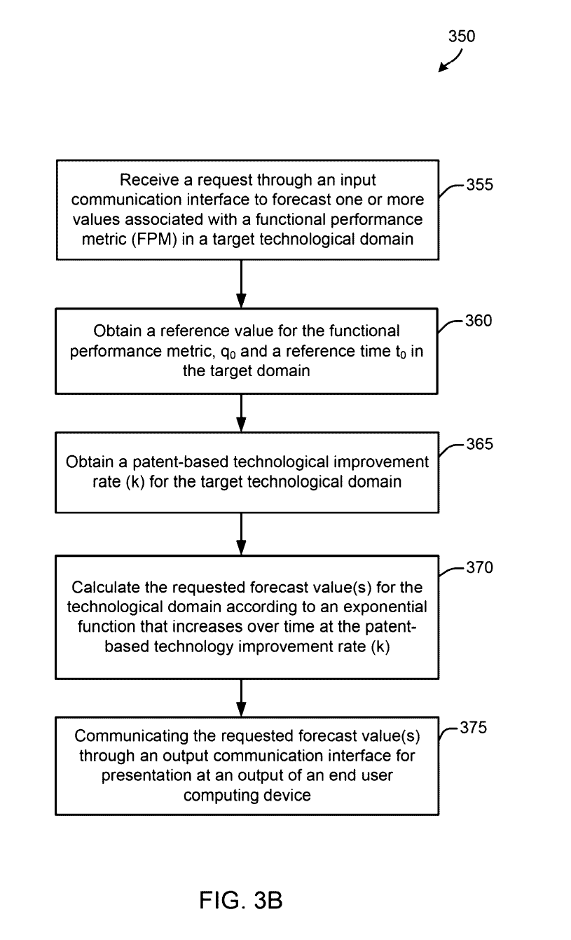

FIG. 3A is a process flow diagram illustrating an embodiment method 300 for quantifying and presenting a patent-based technological improvement rate for a target technological domain.

At block 305, a processor 210 of the TIR server 110 may receive a request through an input communication interface 230 for a patent-based technological improvement rate for a target technological domain. In some embodiments, the request may include input that identifies one or more target technological domains. In some embodiments, the input may be further used to identify (e.g., select or suggest) one or more alternative technological domains. For example, two or more domains may be identified for comparison purposes. Such input may include answering a set of questions to identify the desired domain (e.g., functions desired and the scientific and other knowledge bases of interest). The input may also include a set of search terms descriptive of the target domain, such as keywords, names of companies operating in the target domain, and names of patent inventors, for example. In some embodiments, the input may include a unique identifier for the technological domain that may be associated with a predefined set of search terms for that domain. Blocks 310 through 330 may be performed for each of the target and/or alternative technological domains determined at block 305.

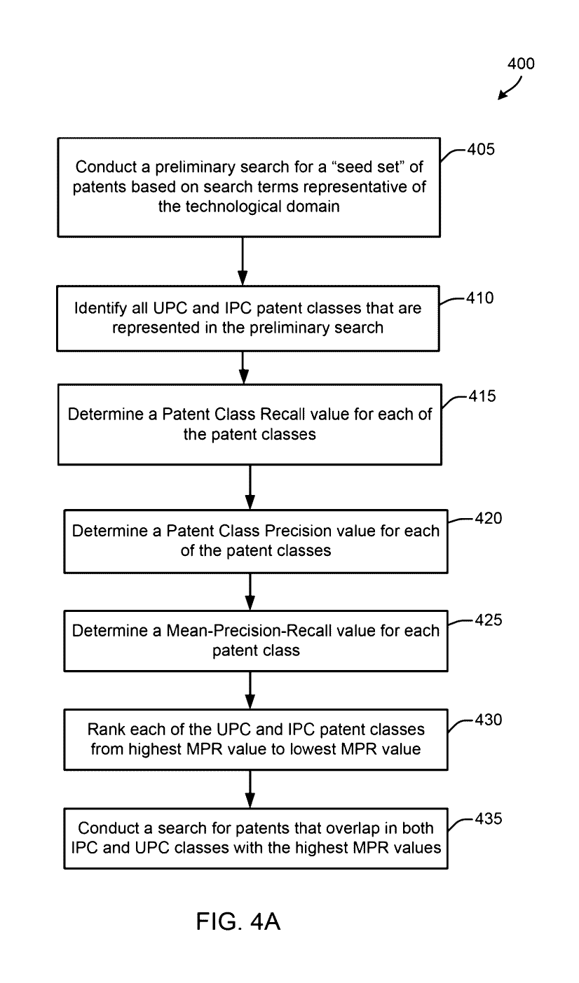

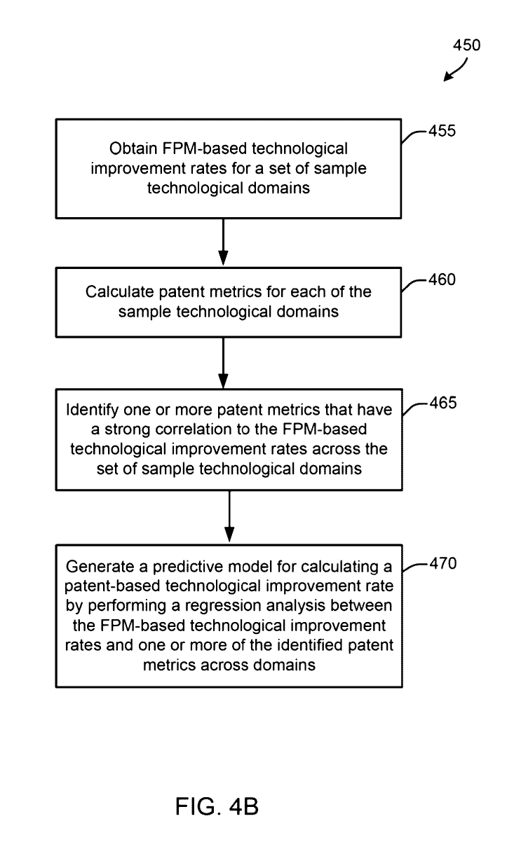

At block 310, the processor 210 of the TIR server 110 may select a set of patents representative of the target technological domain based on an online search of a patent database 130 over the network 140. In some embodiments, the search criteria for the online search of the patent database 130 may be based on the input received at block 305. In some embodiments, the online search of the patent database 130 may be implemented according to a hybrid keyword and patent class methodology, referred to herein as the classification overlap method (“COM”). An embodiment of the COM discussed in more detail with respect to FIG. 4A.

At block 315, the processor 210 of the TIR server 110 may store in memory 220 patent metadata for the selected set of patents. The patent metadata may include bibliographic information associated each patent in the selected set. For example, the patent metadata may include the issue date for each returned patent (“publication date”), information identifying each patent or published patent application that cites to patents in the selected set (“forward citations”), and information identifying each document referenced by each patent in the selected set (“backward citation”). The information identifying each forward citation and backward citation may include the publication date of that citation.

At block 320, the processor 210 of the TIR server 110 may calculate values for one or more patent metrics from the patent metadata of the target technological domain. In some embodiments, the calculated patent metrics may include the average number of forward citations within three years of publication per patent in the selected set (FwdCit₃), the average publication date of backward citations per patent in the selected set (PubYearBkwdCit), the average age of backward citations per patent in the selected set (AgeBkwdCit), the average publication date of the patents in the selected set (PubYear), and the average number of forward citations per patent in the selected set (FwdCit). Each of these patent metrics exhibits a suitable correlation to technological improvement rates calculated using functional performance metrics (i.e., FPM-based TIR) across different technological domains. In some embodiments, patent metrics having a Pearson correlation coefficient (Cp) greater than 0.5 and a statistical null hypothesis acceptance (p-value) equal to or less than 0.05 may be suitable patent metrics for calculating patent-based technological improvement rates as discussed below.

At block 325, the processor 210 of the TIR server 110 may calculate a patent-based technological improvement rate (k) for the target technological domain by applying a predictive model to values of the one or more patent metrics calculated at block 320. In some embodiments, the predictive model may represent a linear function of the one or more patent metrics. In some embodiments, the predictive model may be derived from a linear regression analysis between calculated values of one or more patent metrics and FPM-based technological improvement rates across a set of sample technological domains.

At block 330, the processor 210 of the TIR server 110 may communicate the patent-based technological improvement rate (k) through an output communication interface for presentation through an output of an end-user computing device 150, 160.

In addition to quantifying and presenting users with patent-based technological improvement rates for targeted domains, the patent-based TIR may be used to quantify and present information relating to various functional performance metrics in such domains. FIG. 3B is a process flow diagram illustrating an embodiment method 350 for quantifying functional performance metrics in a target technological domain using the patent-based technological improvement rate calculated according to the embodiment method of FIG. 3A.

At block 355, the processor 210 of the TIR server 110 may receive a request through an input communication interface to forecast one or more values associated with a functional performance metric in a target technological domain. A functional performance metric (FPM) may be any metric used to measure the performance of a specific technological domain. Examples of an FPM may include measures of value and cost to a consumer of a technology. For example, an FPM in the technological domain of “electrochemical batteries” may include energy density, i.e. kilowatt hours per kilogram (kWhr/kg).

In some embodiments, the requested forecast values may include a forecast value of the functional performance metric q at a specified future year t. The requested forecast values may include a range of forecast values of the functional performance metric q extending over a specified time period (e.g., between a current year t₀ and a specified future year t). The requested forecast values may include a forecast year at which the functional performance metric q may be expected to reach a desired value.

At block 360, the processor 210 of the TIR server 110 may obtain a reference value of the functional performance metric q₀ for the target domain at the reference time t₀. In some embodiments, the reference value q₀ and the reference time t₀ may be provided in the request. In some embodiments, the processor 210 of the TIR server 110 may request the reference value q₀ and the reference time t₀ from a locally connected database or a source computing device accessible over the network 130 (e.g., a web server or other database server). In some embodiments, the reference time t₀ may be assumed equal the current year.

At block 365, the processor 210 of the TIR server 110 may obtain the patent-based technological improvement rate (k) for the target domain. In some embodiments, the patent-based technological improvement rate (k) may be calculated according the embodiment method described in FIG. 3A. In some embodiments, the patent-based technological improvement rate (k) may be pre-calculated and obtained from the memory 220.

At block 370, the processor 210 of the TIR server 110 may calculate the requested forecast value(s) for the target technological domain according to an exponential function that increases over time at the estimated technological improvement rate (k). In some embodiments, the exponential function is defined as q=q₀*exp (k*(t−t₀)).

At block 375, the processor 210 of TIR server 110 may communicate the requested forecast value(s) associated with the function performance metric (FPM) of the target domain through an output communication interface for presentation at an output of an end-user computing device.

As discussed above in FIG. 3A, the processor 210 of the TIR server 110 may select a set of patents representative of the technological domain by performing a hybrid keyword and patent class search of the patent database 130, referred to herein as the classification overlap method (“COM”). FIG. 4A is a process flow diagram illustrating an embodiment method 400 for selecting a set of patent representative of the technological domain using COM.

At block 405, the processor 210 of the TIR server 110 may conduct a preliminary search of the patent database 130 to identify a seed set of patents based on search terms representative of the technological domain. Such search terms may be derived from information submitted in block 305. For example, the preliminary search may be conducted using a search query that identifies all patents having the key words “solar photovoltaics” in the abstract or title. In return, the processor 210 receives patent metadata associated with the seed set of patents and stores the metadata in the memory 220.

At block 410, the processor 210 of the TIR server 110 may analyze the patent metadata to identify all of the United States patent classes (UPC) and international patent classes (IPC) associated with patents obtained from the preliminary search.

At block 415, the processor 210 of the TIR server 110 may determine a Patent Class Recall value for each UPC class and a Patent Class Recall value for each IPC class. In some embodiments, the Patent Class Recall value for a patent class may be calculated as the number of patents from the preliminary search in the class divided by the number of patents from the preliminary search.

At block 420, the processor 210 of the TIR server 110 may determine a Patent Class Precision value for each UPC class and a Patent Class Precision value for each IPC class. In some embodiments, the Patent Class Prevision value for a patent class may be calculated as the number of patents from the preliminary search in the class divided by the total number of patents in the class. The total number of patents in a class may be determined by conducting another search of the patent database 130 using the class identifier as the search query.

At block 425, the processor 210 of the TIR server 110 may determine a Mean-Prevision-Recall (MPR) value for each of the UPC and IPC classes. In some embodiments, the MPR value for a patent class may be calculated as the arithmetic mean of the Patent Class Recall value and Patent Class Precision value calculated at blocks 415 and 420 for that class.

At block 430, the processor 210 of the TIR server 110 may rank each of the UPC and IPC patent classes according to their respective MPR values from lowest to highest.

At block 440, the processor 210 of the TIR server 110 may conduct a search for patents that overlap in both UPC and IPC patent classes with the highest MPR values (e.g., top two classes in both the UPC and IPC patent classes). The set of patents resulting from this search may be used as the selected set of patents representative of the technological domain.

As discussed above in FIG. 3A, the processor 210 of the TIR server 110 may calculate the patent-based technological improvement rate (k) for a target technological domain by applying a predictive model to calculated values of one or more patent metrics for that domain. FIG. 4B is a process flow diagram illustrating an embodiment method 450 for generating a predictive model that calculates patent-based technological improvement rates based on patent metrics across technological domains.

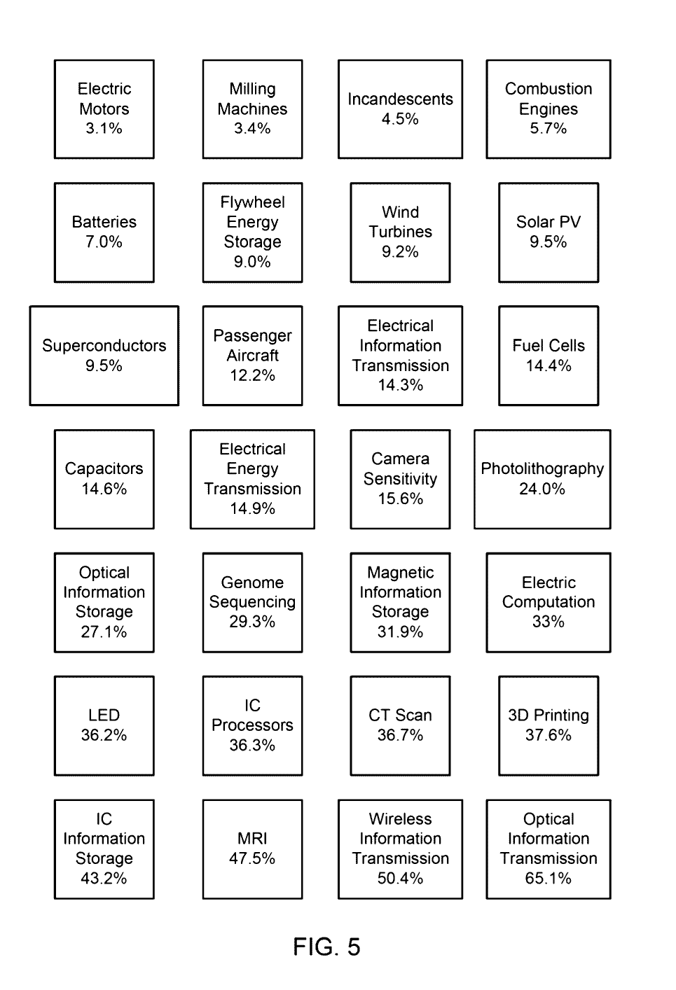

At block 455, the processor 210 of the TIR server 110 may receive functional performance metric (FPM)-based technological improvement rates for a set of sample technological domains over an input communication interface 230. For example, FIG. 5 is a diagram that identifies FPM-based technological improvement rates for a set of sample technological domains. The FPM-based technological improvement rates for each domain may be calculated based on historical data obtained from various sources, including product specifications, trade magazines, scientific literature, and industry reports, for example.

At block 460 of FIG. 4B, the processor 210 of the TIR server 110 may calculate one or more patent metrics for each of the sample technological domains. For example, in some embodiments, the processor 210 of the TIR server 110 may perform a COM search of a patent database 130 as described in FIG. 4A to select a set of patents representative for each of the sample technological domains. The COM search for each of the sample technological domains may be based on a pre-determined set of search terms. The processor 210 may receive and store in memory 220 patent metadata corresponding to the selected set of patents for each domain. From the patent metadata, the processor 210 may calculate one or more patent metrics corresponding to each of sample technological domains.

At block 465, the processor 210 of the TIR server 110 may identify one or more patent metrics having a suitable correlation to the FPM-based technological improvement rates across the set of sample technological domains. In some embodiments, patent metrics having a Pearson correlation coefficient (Cp) equal to or greater than 0.5 and a statistical null hypothesis acceptance (p-value) equal to or less than 0.05 may be suitable patent metrics for calculating patent-based technological improvement rates.

At block 470, the processor 210 of the TIR server 110 may generate a predictive model for calculating patent-based technological improvement rates (k) by performing a regression analysis between FPM-based technological improvement rates input at block 455 and a combination of one or more of the patent metrics identified at block 415 across the sample technological domains.

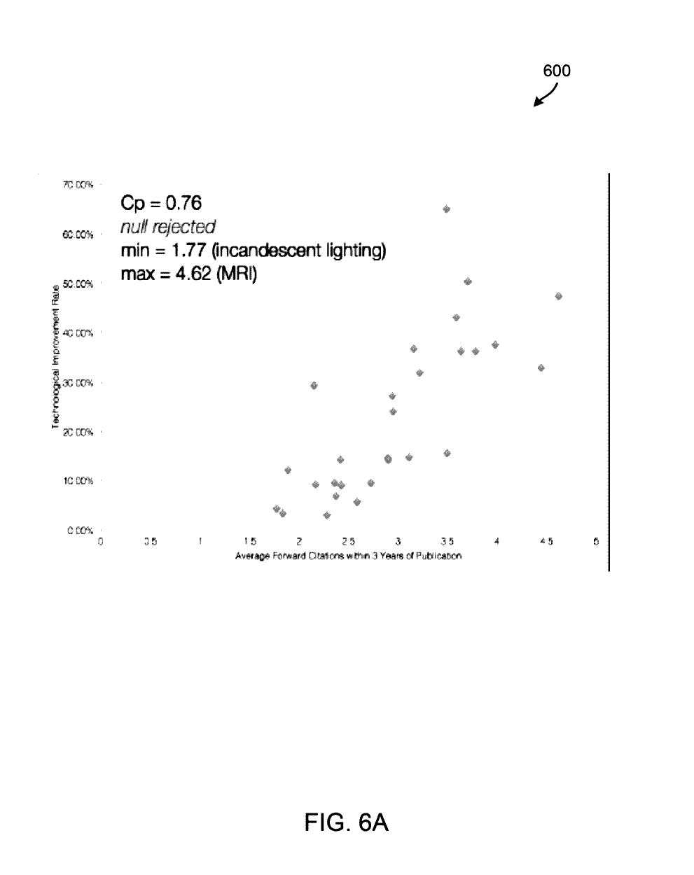

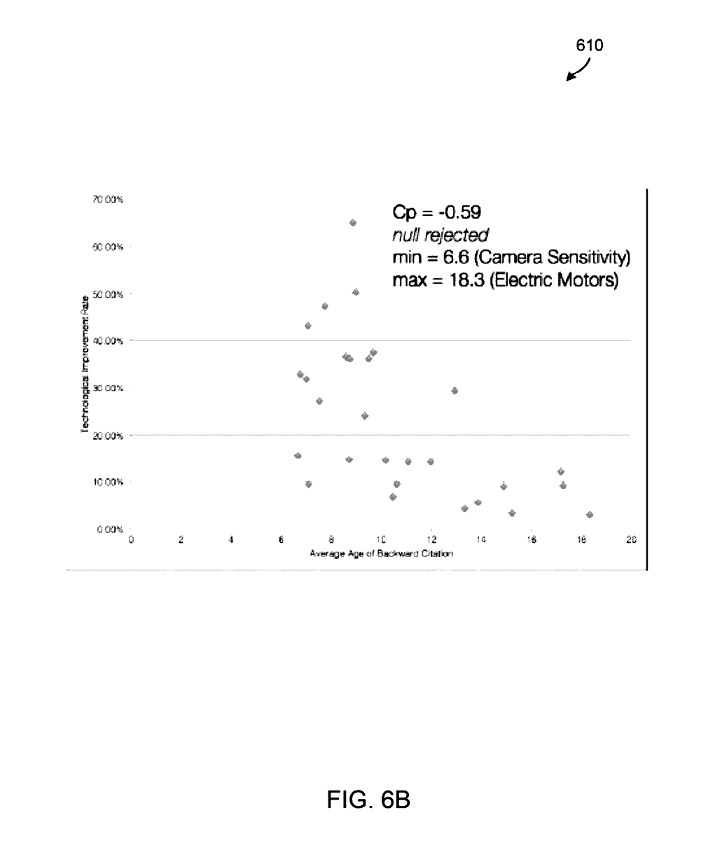

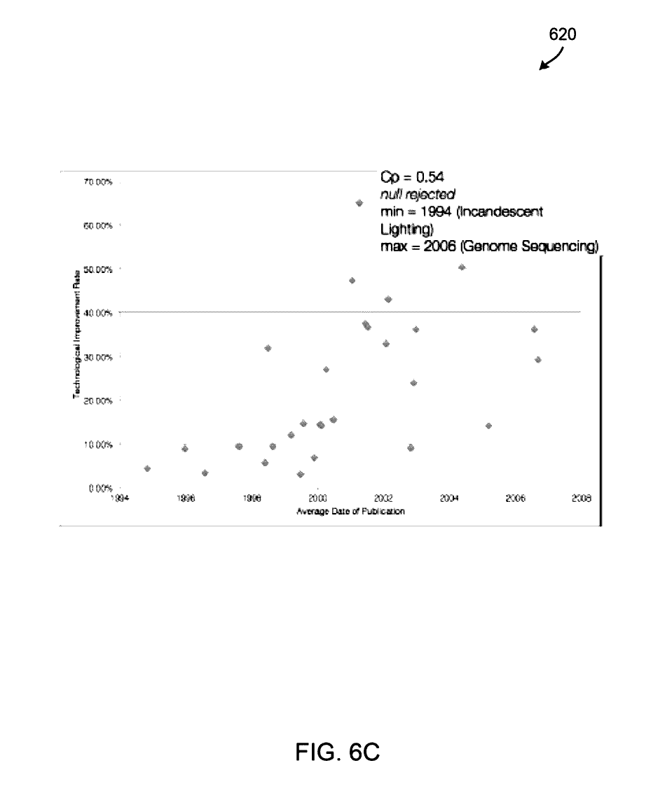

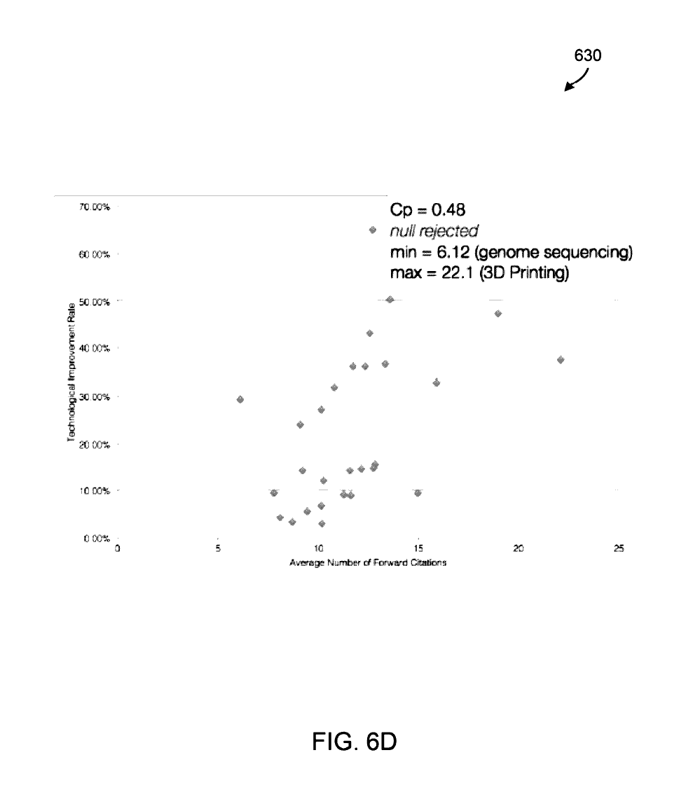

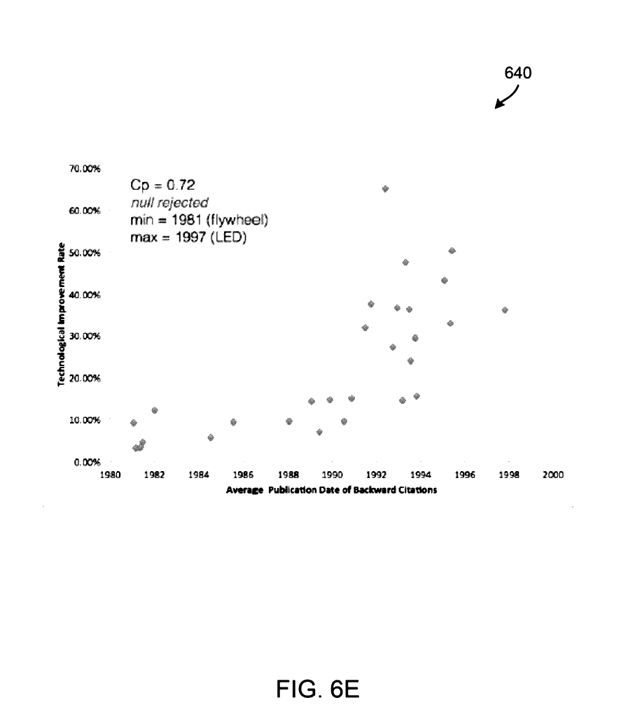

For example, FIGS. 6A-6E are graphs illustrating exemplary patent metrics having suitable correlations to FPM-based technological improvement rates (TIR) across a set of sample technological domains. Each graph may be a Cartesian graph having increasing values of FPM-based technological improvement rates (TIR) along the Y-axis and increasing values of a defined patent metric along the X-axis. Each of plotted points (X, Y) corresponds to an FPM-based TIR and a patent metric value corresponding to one of 28 sample technological domains shown in FIG. 5. According to a statistical analysis of these graphs, each of the exemplary patent metrics has a Pearson correlation coefficient (Cp) equal to or greater than 0.5 and a statistical null hypothesis acceptance (p-value) equal to or less than 0.05, thus indicating that the correlation is unlikely to be due to random scattering of the data.

For example, FIG. 6A is a graph 600 for the FwdCit₃ patent metric. The FwdCit₃ patent metric may be defined as the average number of forward citations that each patent received within three years of publication for patents in a technological domain. The FwdCit₃ patent metric may be calculated according to the equation (2), where SPC is a simple patent count of the patents in a technological domain, FCᵢ is the number of forward citations for patent i, t_{ipub}, is the publication year of patent i, t_{ijpub} is the publication year of forward citation j of patent i, and the function IF(arg) only counts the values if the argument is satisfied:

$${\sum }_{i = 1}^{SPC} {\sum }_{j = 1}^{{FC}_{i}} IF ( {t}_{{ij}_{pub}} - {t}_{{i}_{pub}} \leq 3 ) \qquad ( 2 )$$

FIG. 6B is a graph 610 for the AgeBkwdCit patent metric. The AgeBkwdCit patent metric may be defined as the average age of backward citations per patent for patents in a technological domain. The AgeBkwdCit patent metric may be calculated according to the equation (3), where SPC is a simple patent count of the patents in a technological domain, BCᵢ is the number of backward citations for patent i, t_{jipub} is the publication year of backward citation j of patent i, t_{ipub} is the publication year of patent i:

$$\frac{{\sum }_{i = 1}^{SPC} {t}_{{i}_{pub}}}{SPC} - \frac{{\sum }_{i = 1}^{SPC} {\sum }_{j = 1}^{{BC}_{i}} {t}_{{ji}_{pub}}}{{\sum }_{i = 1}^{SPC} {\sum }_{j = 1}^{{BC}_{i}} 1} \qquad ( 3 )$$

FIG. 6C is a graph 620 for the PubYear patent metric. The PubYear patent metric may be defined as the average date (e.g., year) of publication for patents in a technological domain. The PubYear patent metric may be calculated according to the equation (4), where SPC is a simple patent count of the patents in a technological domain and t_{ipub} is the publication year of patent i:

$$\frac{{\sum }_{i = 1}^{SPC} {t}_{{i}_{pub}}}{SPC} \qquad ( 4 )$$

FIG. 6D is a graph 630 for the FwdCit patent metric. The FwdCit patent metric may be defined as the average number of forward citations that each patent received for patents in a technological domain. The FwdCit patent metric may be calculated according to the equation (5), where SPC is a simple patent count of the patents in a technological domain and FCᵢ is the number of forward citations for patent i. The summation in the numerator is the sum of the total count of forward citations for all patent in the technological domain (without duplicate removed):

$$\frac{{\sum }_{i = 1}^{SPC} {\sum }_{j = 1}^{{FC}_{i}} 1}{SPC} \qquad ( 5 )$$

FIG. 6E is a graph 640 for the PubYearBkwdCit patent metric. The PubYearBkwdCit patent metric may be defined as the average publication date of backward citations per patent in a technological domain. The PubYearBkwdCit patent metric may be calculated according to the equation (6), where SPC is the simple patent count of the patent in a technological domain, BCᵢ is the number of backward citations for patent i, t_{jipub} is the publication year of backward citation j of patent i, t_{ipub} is the publication year of patent i:

$$\frac{{\sum }_{i = 1}^{SPC} {\sum }_{j = 1}^{{BC}_{i}} {t}_{{ji}_{pub}}}{{\sum }_{i = 1}^{SPC} {\sum }_{j = 1}^{{BC}_{i}} 1} \qquad ( 6 )$$

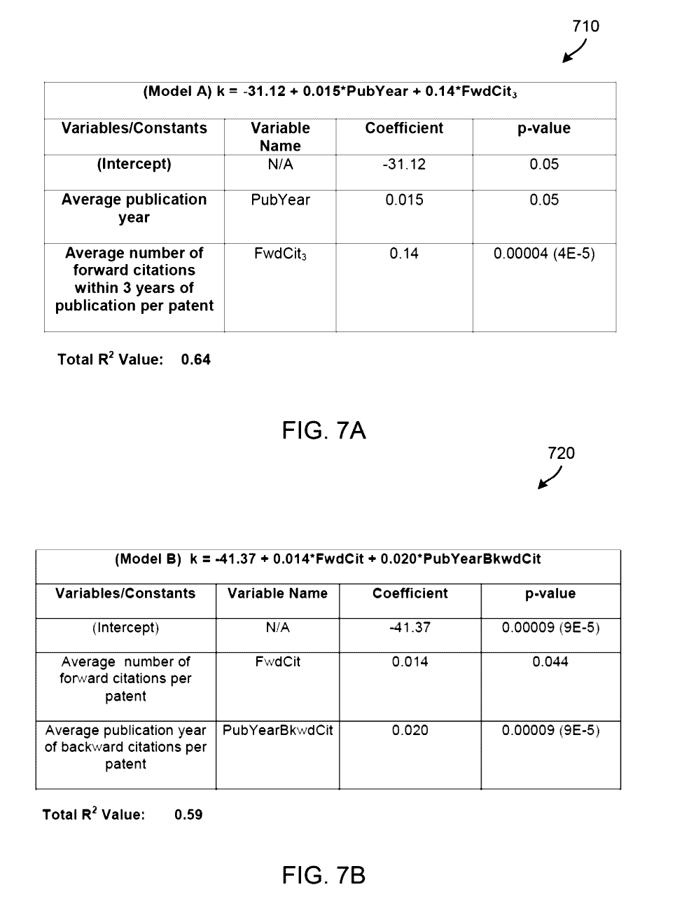

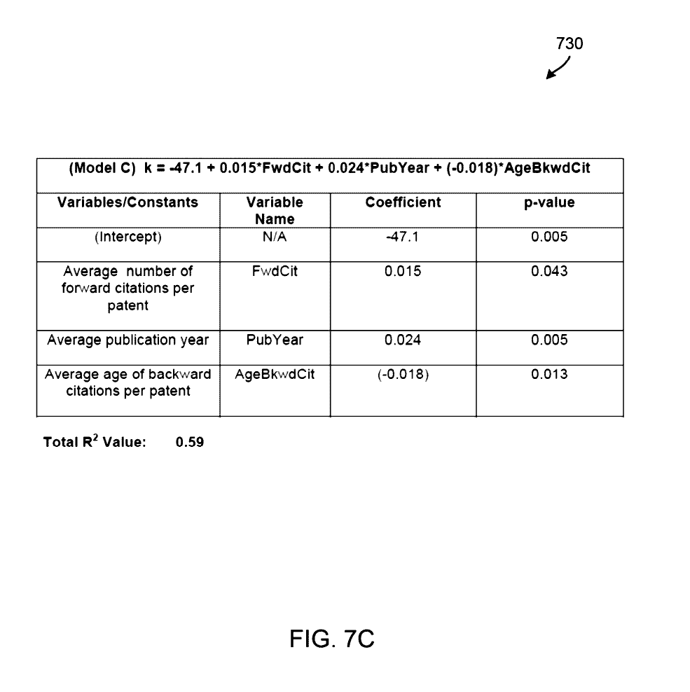

FIGS. 7A-7C are tables illustrating exemplary predictive regression models based on various combinations of the patent metrics of FIGS. 6A-6E. For example, in FIG. 7A, table 710 defines a predictive model for calculating patent-based technological improvement rates (k) as a function of the average year of publication for patents in a technological domain (PubYear) and the average number of forward citations that each patent received within three years of publication for patents in a technological domain (FwdCit₃). As shown, the predictive model (Model A) may be defined according to equation (7):

k=−31.12+0.015*PubYear+0.14*FwdCit₃ (7).

As shown, Model A is associated with a high coefficient of determination (R²=0.64) and low null hypothesis acceptance value (p-values ≦0.05), which is indicative of this patent-based model being strongly correlated to FPM-based technological improvement rates.

In FIG. 7B, table 720 defines a predictive model for calculating patent-based technological improvement rates (k) as a function of the average number of forward citations that each patent received for patents in a technological domain (FwdCit) and the average publication date of backward citations per patent in a technological domain (PubYearBkwdCit). As shown, the predictive model (Model B) may be defined according to equation (8):

k=−41.37+0.014*FwdCit+0.020*PubYearBkwdCit (8)

As shown, Model B is associated with a high coefficient of determination (R²=0.59) and low null hypothesis acceptance value (p-values ≦0.05), which is indicative of this patent-based model also being strongly correlated to FPM-based technological improvement rates.

In FIG. 7C, table 730 defines a predictive model for calculating patent based technological improvement rates (k) as a function of the average number of forward citations that each patent received for patents in a technological domain (FwdCit), the average year of publication for patents in a technological domain (PubYear), and the average age of backward citations per patent for patents in a technological domain (AgeBkwdCit). The predictive model (Model C) may be defined according to equation (9):

k=−47.1+0.015*FwdCit+0.024*PubYear+(−0.018)*AgeBkwdCit (9)

As shown, Model C is associated with a high coefficient of determination (R²=0.59) and low null hypothesis acceptance value (p-values ≦0.05), which is indicative of this patent-based model also being strongly correlated to FPM-based technological improvement rates.

The systems, methods and devices disclosed herein may be incorporated into a number of different applications. In some embodiments, an investment tool executing on one or more of an end user computing device 150, 160 and an application server 120 may be configured to communicate with the TIR server 110 to enable comparison of user-selected technological domains based on their respective patent-based TIRs.

For example, the investment tool may be configured to provide a user interface through which an investor may input a selection of two or more technological domains (e.g., “super capacitors” and “batteries”) for communication to the TIR server 110. In response, the TIR server 110 may communicate the corresponding patent-based technological improvement rates for each domain back to the investment tool for presentation through a display of the end user device 150, 160. The investment tool may be configured to present an ordered listing of the selected domains through the user interface according to their respective patent-based TIRs (e.g., from highest to lowest). The ordered listing of technological domains may be useful to an investor looking to invest only in technologies expected to have high rates of technological improvement. The ordered listing of technological domains may also be useful to an investor looking to invest in technologies expected to have low rates of technological improvement. For example, technological domains having low rates of technological improvement may be due to large barriers to entry, and thus worthy of investment in companies overcoming such barriers. Where the selected technological domains relate to competing technologies, the ordered listing of competing domains may be useful in making long investments in domains having higher TIRs (e.g., a disruptive technologies) and short investments in domains having lower TIRs (e.g., older technologies).

Such an investment tool may also be useful for any organization that is responsible for making decisions to fund research and development (R&D) in a large variety of technologies. One of the main attributes that may be considered when investing funds into researching a technology may be the likelihood that the technology may mature into a useful product. Patent-based TIR information may be utilized as a useful estimation for such decisions. For example, assume that the a government agency may be deciding whether to fund research in technology X or technology Y and both areas have promising researchers who have submitted requests for funding and potential applications in the future. If the patent-based TIR for technology X is 30% and the patent-based TIR for technology Y is 8%, it may make more sense to invest the funds in technology X.

In some embodiments, a product development tool executing on one or more of an end user computing device 150, 160 and an application server 120 may be configured to communicate with the TIR server 110. In such embodiments, the TIR server 110 may enable a product designer or engineering manager to identify components of a product design that should be designed for replacement over the course of a long term development. For example, a technological component in a domain having a high patent-based TIR may be a likely candidate for placement over the course of a long term development than a technological component in a domain having a low patent-based TIR. In this manner, patent-based TIR information may be useful to prevent a design from being locked into an ineffective set of technologies from the beginning of the design process.

For example, the product development tool may provide a user interface through which a designer may layout the functional requirements for various components for a product, e.g., an electric car. In the design of the electric car, such components may include a motor, a metal frame, an energy storage unit, and system computers. Each of these components may be implemented by a number of different technological domains. For example, the motor may be implemented using neodymium motors, brushless motors, or induction motors. The frame may be constructed from numerous metals such as aluminum, steel, carbon fiber, and titanium. The energy storage unit may be implemented using batteries, capacitors, or hydrogen fuel cells. The system computers may be implemented using IC processors, solid state memory or magnetic information storage.

The product development tool may be configured to provide a user interface through which the designer or manager may input a selection of two or more competing technological domains for each of these components and communicate the selections to the TIR server 110. In response, the TIR server 110 may communicates the respective patent-based TIRs for each of the competing domains back to the product development tool for presentation through a display of the end user device 150, 160. The investment tool may be configured to present an ordered listing of the selected domains for each component through the user interface according to their respective patent-based TIRs (e.g., from highest to lowest). The ordered listing of technological domains for each component may be used to enable the designer or manager to determine which aspects of the design may be finalized early and which aspects of the design should be finalized later. For example, assuming the patent-based TIRs for each of the various energy storage domains (e.g., batteries, capacitors, and hydrogen fuel cells) is high, the product designer or manager may decide to delay the final design specification for the energy storage component. Conversely, assuming the patent-based TIRs for each of the various motor domains (e.g., neodymium motors, brushless motors, and induction motors) is low, the designer or manager may decide to finalize the design specifications for the motor component as the underlying technologies appear more stable.

Such projections may also allow a product development team to balance long-term functional requirements, such as range and cost, and thus potentially increase the useful cycle life of the product. The designer or manager may also use the patent-based TIR information to forecast specifications for various components of the product even though the final product may have a long-term release date (e.g., years).

For example, the product development tool may be configured to provide a user interface through which the designer or manager may request the TIR server 110 to forecast values for a target domain for one of the components (e.g., batteries). The request may include a current capability (or FPM) for that domain (e.g., miles per charge). In the response, the TIR server 110 may forecast values for the requested FPM (e.g., miles per charge) according to an exponential function that increases over time at the patent-based technological improvement rate calculated for the selected domain (e.g., batteries) and communicate such values back to the product development tool for presentation through a display of the end user device 150, 160.

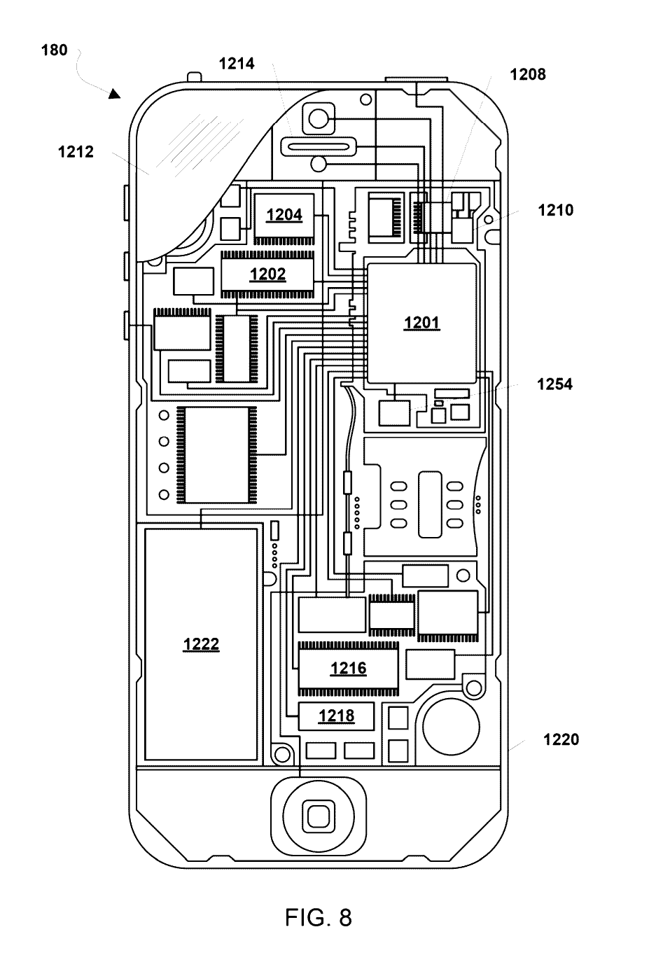

FIG. 8 illustrates an embodiment smartphone mobile device 180 for use in various embodiments. The smartphone mobile device may include a processor 1201 coupled to a touch screen controller 1204 and an internal memory 1202. The processor 1201 may be one or more multicore ICs designated for general or specific processing tasks. The internal memory 1202 may be volatile or non-volatile memory, and may also be secure and/or encrypted memory, or unsecure and/or unencrypted memory, or any combination thereof. The touch screen controller 1204 and the processor 1201 may also be coupled to a touch screen panel 1212, such as a resistive-sensing touch screen, capacitive-sensing touch screen, infrared sensing touch screen, etc. The smartphone mobile device may have one or more radio signal transceivers 1208 (e.g., Peanut®, Bluetooth®, Zigbee®, Wi-Fi, RF radio) and antennae 1210, for sending and receiving, coupled to each other and/or to the processor 1201. The transceivers 1208 and antennae 1210 may be used with the above-mentioned circuitry to implement the various wireless transmission protocol stacks and interfaces. The smartphone mobile device may include a cellular network wireless modem chip 1216 that enables communication via a cellular network and is coupled to the processor 1201. The smartphone mobile device may include a peripheral device connection interface 1218 coupled to the processor 1201. The peripheral device connection interface 1218 may be singularly configured to accept one type of connection, or multiply configured to accept various types of physical and communication connections, common or proprietary, such as USB, FireWire, Thunderbolt, or PCIe. The peripheral device connection interface 1218 may also be coupled to a similarly configured peripheral device connection port (not shown). The smartphone mobile device may also include speakers 1214 for providing audio outputs. The smartphone mobile device may also include a housing 1220, constructed of a plastic, metal, or a combination of materials, for containing all or some of the components discussed herein. The smartphone mobile device may include a power source 1222 coupled to the processor 1201, such as a disposable or rechargeable battery. The rechargeable battery may also be coupled to the peripheral device connection port to receive a charging current from a source external to the smartphone mobile device. Additionally, the smartphone mobile device may include a GPS receiver chip 1254 coupled to the processor 1201.

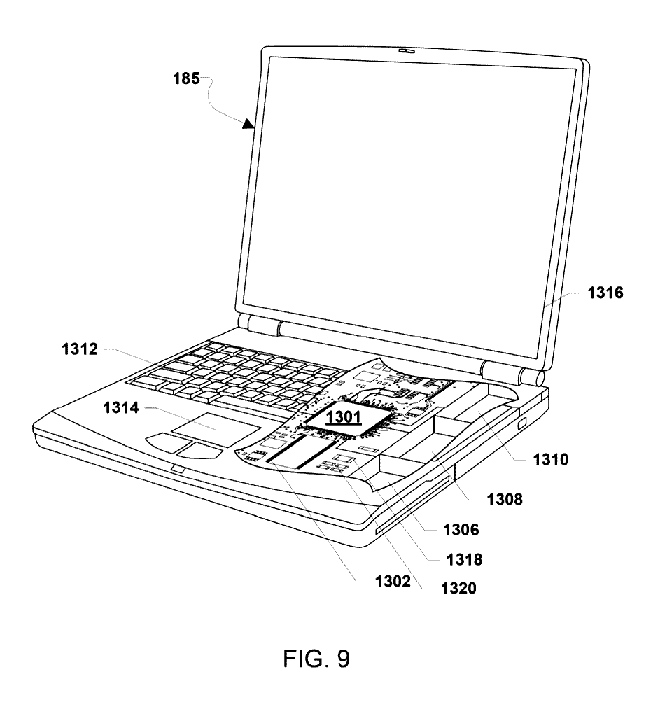

Other forms of computing devices, including personal computers and laptop computers, may be used to implementing the various embodiments. Such computing devices typically include the components illustrated in FIG. 9 which illustrates an example laptop computing device 185. Many laptop computers include a touch pad 1314 that serves as the computer's pointing device, and thus may receive drag, scroll, and flick gestures similar to those implemented on mobile computing devices equipped with a touch screen display and described above. Such a laptop computing device 185 generally includes a processor 1301 coupled to volatile internal memory 1302 and a large capacity nonvolatile memory, such as a disk drive 1306. The laptop computing device 185 may also include a compact disc (CD) and/or DVD drive 1308 coupled to the processor 1301. The laptop computing device 185 may also include a number of connector ports 1310 coupled to the processor 1301 for establishing data connections or receiving external memory devices, such as a network connection circuit for coupling the processor 1301 to a network. The laptop computing device 185 may have one or more radio signal transceivers 1318 (e.g., Peanut®, Bluetooth®, ZigBee®, RF radio) and antennas 1320 for sending and receiving wireless signals as described herein. The transceivers 1318 and antennas 1320 may be used with the above-mentioned circuitry to implement the various wireless transmission protocol stacks/interfaces. In a laptop or notebook configuration, the computer housing includes the touch pad 1314, the keyboard 1312, and the display 1316 all coupled to the processor 1301. Other configurations of the computing device may include a computer mouse or trackball coupled to the processor (e.g., via a USB input) as are well known, which may also be used in conjunction with the various embodiments.

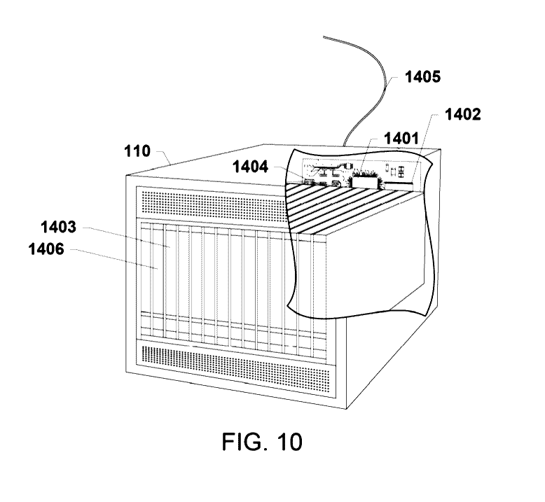

The various embodiments may be implemented on any of a variety of commercially available server devices, such as the server computing device 110 illustrated in FIG. 10. Such a server computing device 110 typically includes a processor 1401 coupled to volatile memory 1402 and a large capacity nonvolatile memory, such as a disk drive 1403. The server computing device 110 may also include a floppy disc drive, compact disc (CD) or DVD disc drive 1406 coupled to the processor 1401. The server computing device 110 may also include network access ports 1404 coupled to the processor 1401 for establishing data connections with a network 1405, such as a local area network coupled to other broadcast system computers and servers.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory computer-readable or server-readable medium or a non-transitory processor-readable storage medium. The steps of a method or algorithm disclosed herein may be embodied in a processor-executable software module which may reside on a tangible, non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A server computing device for quantifying and presenting information representative of technological improvements in a target technological domain based on patent metrics, comprising a processor coupled to a memory, wherein the processor is configured with processor-executable instructions to cause the server computing device to:
receive a request for a patent-based technological improvement rate through an input communication interface, the request including information for identifying a target technological domain;
select a set of patents representative of the target technological domain from an online search of a patent database over a network;
store patent metadata in a memory for the set of patents received over the network from the online search of the patent database;
calculate values for one or more patent metrics from the patent metadata for the target technological domain;
calculate the patent-based technological improvement rate for the target technological domain by applying a predictive model to the one or more patent metric values for the target technological domain; and
communicate the patent-based technological improvement rate through an output communication interface for presentation through an output of an end user computing device.

2. The server computing device of claim 1, wherein the processor is further configured with processor-executable instructions to cause the server computing device to:
receive a request through the input communication interface to forecast one or more values associated with a functional performance metric in the target technological domain;
obtain a reference value for the functional performance metric at a reference time in the target technological domain;
obtain the patent-based technological improvement rate for the target technological domain;
calculate the one or more requested forecast values for the technological domain according to an exponential function that increases over time at the patent-based technological improvement rate; and
communicate the one or more requested forecast values associated with the functional performance metric over an output communication interface for presentation at an output of an end user computing device.

3. The server computing device of claim 1, wherein each of the one or more patent metrics correlates to technological improvement rates that are calculated based on historical functional performance metrics across a plurality of technological domains, wherein each of the one or more patent metrics has a Pearson correlation coefficient greater than 0.50.

4. The server computing device of claim 3, wherein the predictive model is derived from a regression analysis between values calculated for the one or more patent metrics across a plurality of technological domains and the technological improvement rates that are calculated based on historical functional performance metrics across the plurality of technological domains.

5. The server computing device of claim 1, wherein the one or more patent metrics are selected from the group consisting of an average number of forward citations within three years of publication per patent in the set of patents (FwdCit₃), an average publication date of backward citations per patent in the set of patents (PubYearBkwdCit), an average age of backward citations per patent in the set of patents (AgeBkwdCit), an average publication date of the set of patents (PubYear), and an average number of forward citations per patent in the set of patents (FwdCit).

6. The server computing device of claim 1, wherein the one or more patent metrics comprise an average number of forward citations within three years of publication per patent in the set of patents (FwdCit₃) and an average publication date of the set of patents (PubYear), the predictive model for the patent-based technological improvement rate (k) being defined as k=−31.12+0.02*PubYear+0.14*FwdCit₃.

7. The server computing device of claim 1, wherein the one or more patent metrics comprise an average number of forward citations per patent in the set of patents (FwdCit) and an average publication date of backward citations per patent in the set of patents (PubYearBkwdCit), the predictive model for the patent-based technological improvement rate (k) being defined as k=−41.37+0.014*FwdCit+0.020*PubYearBkwdCit.

8. The server computing device of claim 1, wherein the one or more patent metrics comprise an average number of forward citations per patent in the set of patents (FwdCit), an average publication date of the set of patents (PubYear), and an average age of backward citations per patent in the set of patents (AgeBkwdCit), the predictive model for the patent-based technological improvement rate (k) being defined as
k=−47.1+0.015*FwdCit+0.024*PubYear+(−0.018)*AgeBkwdCit.

9. The server computing device of claim 1, wherein the request includes information for identifying the target technological domain and at least one alternative technological domain.

10. A computerized method for quantifying and presenting information representative of technological improvements in a target technological domain based on patent metrics, comprising:
receiving, by a server computing device, a request for a patent-based technological improvement rate through an input communication interface, the request including information for identifying a target technological domain;
selecting, by the server computing device, a set of patents representative of the target technological domain from an online search of a patent database over a network;
storing, by the server computing device, patent metadata in a memory for the set of patents received over the network from the online search of the patent database;
calculating, by the server computing device, values for one or more patent metrics from the patent metadata for the target technological domain;
calculating, by the server computing device, the patent-based technological improvement rate for the target technological domain by applying a predictive model to the one or more patent metric values for the target technological domain; and
communicating, by the server computing device, the patent-based technological improvement rate through an output communication interface for presentation through an output of an end user computing device.

11. The method of claim 10, further comprising:
receiving, by the server computing device, a request through the input communication interface to forecast one or more values associated with a functional performance metric in the target technological domain;
obtaining, by the server computing device, a reference value for the functional performance metric at a reference time in the target technological domain;
obtaining, by the server computing device, the patent-based technological improvement rate for the target technological domain;
calculating, by the server computing device, the one or more requested forecast values for the technological domain according to an exponential function that increases over time at the patent-based technological improvement rate; and
communicating, by the server computing device, the one or more requested forecast values associated with the functional performance metric over an output communication interface for presentation at an output of an end user computing device.

12. The method of claim 10, wherein each of the one or more patent metrics correlates to technological improvement rates that are calculated based on historical functional performance metrics across a plurality of technological domains, wherein each of the one or more patent metrics has a Pearson correlation coefficient greater than 0.50.

13. The method of claim 10, wherein the one or more patent metrics comprise an average number of forward citations within three years of publication per patent in the set of patents (FwdCit₃) and an average publication date of the set of patents (PubYear), the predictive model for the patent-based technological improvement rate (k) being defined as k=−31.12+0.02*PubYear+0.14*FwdCit₃.

14. The method of claim 10, wherein the one or more patent metrics comprise an average number of forward citations per patent in the set of patents (FwdCit) and an average publication date of backward citations per patent in the set of patents (PubYearBkwdCit), the predictive model for the patent-based technological improvement rate (k) being defined as k=−41.37+0.014*FwdCit+0.020*PubYearBkwdCit.

15. The method of claim 10, wherein the one or more patent metrics comprise an average number of forward citations per patent in the set of patents (FwdCit), an average publication date of the set of patents (PubYear), and an average age of backward citations per patent in the set of patents (AgeBkwdCit), the predictive model for the patent-based technological improvement rate (k) being defined as
k=−47.1+0.015*FwdCit+0.024*PubYear+(−0.018)*AgeBkwdCit.

16. A non-transitory processor-readable storage medium having stored thereon processor-executable instructions configured to cause a processor of a server computing device to perform operations for quantifying and presenting information representative of technological improvements in a target technological domain based on patent metrics, the operations comprising:
receiving a request for a patent-based technological improvement rate through an input communication interface, the request including information for identifying a target technological domain;
selecting a set of patents representative of the target technological domain from an online search of a patent database over a network;
storing patent metadata in a memory for the set of patents received over the network from the online search of the patent database;
calculating values for one or more patent metrics from the patent metadata for the target technological domain;
calculating the patent-based technological improvement rate for the target technological domain by applying a predictive model to the one or more patent metric values for the target technological domain; and
communicating the patent-based technological improvement rate through an output communication interface for presentation through an output of an end user computing device.

17. The non-transitory processor-readable storage medium of claim 16, wherein the stored processor-executable instructions are configured to cause the processor of the server computing device to perform operations further comprising:
receiving a request through the input communication interface to forecast one or more values associated with a functional performance metric in the target technological domain;
obtaining a reference value for the functional performance metric at a reference time in the target technological domain;
obtaining the patent-based technological improvement rate for the target technological domain;
calculating the one or more requested forecast values for the technological domain according to an exponential function that increases over time at the patent-based technological improvement rate; and
communicating the one or more requested forecast values associated with the functional performance metric over an output communication interface for presentation at an output of an end user computing device.

18. The non-transitory processor-readable storage medium of claim 16, wherein the one or more patent metrics comprise an average number of forward citations within three years of publication per patent in the set of patents (FwdCit₃) and an average publication date of the set of patents (PubYear), the predictive model for the patent-based technological improvement rate (k) being defined as k=−31.12+0.02*PubYear+0.14*FwdCit₃.

19. The non-transitory processor-readable storage medium of claim 16, wherein the one or more patent metrics comprise an average number of forward citations per patent in the set of patents (FwdCit) and an average publication date of backward citations per patent in the set of patents (PubYearBkwdCit), the predictive model for the patent-based technological improvement rate (k) being defined as k=−41.37+0.014*FwdCit+0.020*PubYearBkwdCit.

20. The non-transitory processor-readable storage medium of claim 16, wherein the one or more patent metrics comprise an average number of forward citations per patent in the set of patents (FwdCit), an average publication date of the set of patents (PubYear), and an average age of backward citations per patent in the set of patents (AgeBkwdCit), the predictive model for the patent-based technological improvement rate (k) being defined as
k=−47.1+0.015*FwdCit+0.024*PubYear+(−0.018)*AgeBkwdCit.
